(19) United States
(12) Patent Application Publication
(10) Pub. No.: US 2025/0125335 A1
(43) Pub. Date: Apr. 17, 2025

(54) METHOD FOR PRODUCING PARTIALLY REACTED SILICON FOR THE CONTROL OF THE LITHIUM INTERCALATION CAPACITY, FOR USE IN LITHIUM BATTERIES

(71) Applicant: NORCSI GMBH, Halle (DE)

(72) Inventors: Udo REICHMANN, Wilsdruff (DE); Marcel NEUBERT, Kreischa (DE); Andreas KRAUSE-BADER, Dresden (DE)

(73) Assignee: NORCSI GMBH, Halle (DE)

(21) Appl. No.: 18/681,998

(22) PCT Filed: Aug. 9, 2022
(86) PCT No.: PCT/EP2022/072296

§ 371 Date: Feb. 7, 2024

(30) Foreign Application Priority Data
Aug. 9, 2021 (DE) 10 2021 120 635.9

(51) Int. Cl. H01M 4/134; C01B 33/06; H01M 4/02; H01M 4/04; H01M 4/1395; H01M 4/38; H01M 4/62; H01M 10/42

(52) U.S. Cl. CPC H01M 4/134; C01B 33/06; H01M 4/0404; H01M 4/0423; H01M 4/0428; H01M 4/0471; H01M 4/1395; H01M 4/386; H01M 4/626; H01M 10/4235; C01P 2004/03; C01P 2006/40; H01M 2004/021; H01M 2004/027

(57) ABSTRACT

The invention relates to a method for producing partially reacted silicon for the control of the lithium intercalation capacity, for use in lithium batteries, wherein a first silicon layer is deposited on a substrate, the first silicon layer subsequently being subjected to rapid thermal processing. The invention also relates to an anode thereby produced. The problem addressed by the present invention of specifying a method that allows control of the capacity of ion intercalation into functional layers for battery production is solved in that a layer of silicon, metal and/or another material is applied as a diffusion barrier, which is subjected to subsequent rapid thermal processing, and partially reacted silicon is formed. (The structure of the diffusion barrier makes the diffusion barrier permeable to lithium.)

The invention relates to a method for producing partially reacted silicon for controlling the lithium intercalation capacity, for use in lithium batteries, wherein a first silicon layer is deposited on a substrate and is subsequently subjected to accelerated annealing.

The invention also relates to an anode which is suitable for use in a lithium battery and is produced with the method of the invention.

The invention likewise relates to the use of the method for functional strata in aluminum-ion batteries, and to the use of the method for producing partially reacted silicon for controlling the ion intercalation capacity in the production of sodium batteries and magnesium batteries.

Electrochemical energy storage is a vital cornerstone in the global efforts toward energy transition, serving to provide interim storage of fluctuating power generated by regenerative means and to make it available to static and mobile applications. Mitigating against raw materials-based scarcity and hence increasing costs for secondary batteries in particular requires not only a diversification of the energy storage concepts, but also new materials. These materials ought both to improve the technical performance of such energy storage concepts (including capacity, energy density, lifetime) and to minimize the costs of production. The latter can be ensured in particular through the use of readily available chemical elements, as represented by silicon, for which a broad technology basis already exists.

Batteries are electrochemical energy stores and are differentiated as primary and secondary batteries.

Primary batteries are electrochemical power sources in which chemical energy is converted irreversibly into electrical energy. A primary battery is therefore not rechargeable. Secondary batteries, also called accumulators, on the other hand, are rechargeable electrochemical energy stores in which the chemical reaction that takes place is reversible, enabling multiple use. During charging, electrical energy is converted into chemical energy, and on discharge it is converted back from chemical to electrical energy.

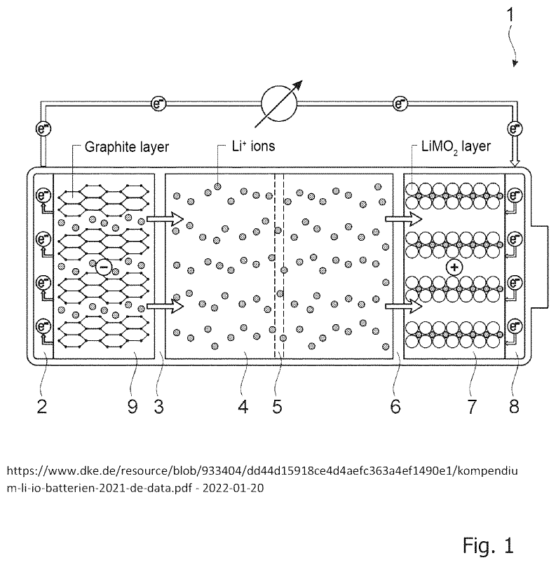

“Battery” is the headline term for interconnected cells. Cells are galvanic units which consist of two electrodes, electrolyte, separator, and cell casing. FIG. 1 shows an illustrative construction and the function of a lithium-ion cell during discharging. The constituents of a cell are briefly elucidated below.

Each Li-ion cell 1 consists of two different electrodes 7, 9: an electrode 7, which is negatively charged in the charged state, and an electrode 9, which is positively charged in the charged state. Since release of energy, in other words discharge, is accompanied by migration of ions from the negatively charged electrode to the positively charged electrode, the positively charged electrode is called the cathode 7 and the negatively charged electrode is called the anode 9. The electrodes are each composed of a current collector 2, 8 and of an active material applied thereon. Located between the electrodes are firstly the ion-conducting electrolyte 4, which enables the required exchange of charge, and the separator 5, which ensures electrical separation of the electrodes.

The cathode consists, for example, of mixed oxides applied on an aluminum collector. Transition metal oxides with cobalt (Co), manganese (Mn) and nickel (Ni) or aluminum oxide (Al₂O₃) are the most common compounds here. The applied metal oxide layer serves for intercalation of the lithium ions during discharge of the cell.

The anode of the Li-ion cell may consist of a copper foil as collector and of a layer of carbon as active material. The carbon compound used is usually natural or synthetic graphite, as it possesses a low electrode potential and exhibits little volume expansion during charging and discharging. During charging, lithium ions are reduced and intercalated into the graphite layers.

In constructions for lithium-ion batteries, the cathode typically supplies the lithium atoms for charging and discharge in the anode, and hence the battery capacity is limited by the cathode capacity. As already mentioned, typical cathode materials used to date are, for example, Li(Ni,Co,Mn)O₂ and LiFePO₄. Because of the construction of the cathode by lithium metal oxides, possibilities for boosting the capacity are minimal.

Also known for use with Li battery anodes is silicon rather than carbon. Silicon as an anode material has a high storage capacity of theoretically around 3579 mAh/g for the Li₁₅Si₄ phase at room temperature, as compared with the conventional carbon-type materials, such as graphite with a storage capacity of 372 mAh/g, for example. Challenges arise with the use of silicon as anode material, however, in terms of the sometimes considerable change in volume (volume contraction and expansion) of the host matrix during the intercalation and deintercalation of the mobile ion species during charging and discharge of corresponding energy stores. For graphite, the change in volume is around 10%, whereas for silicon it is around 400%. The change in volume of the anode material when silicon is used leads to internal stresses, cracking, pulverization of the active material of the host matrix (silicon), and ultimately complete destruction of the anode.

Silicon can be applied directly to metal substrates such as copper foils only if there is no temperature step in the ongoing process, since such a step leads to reaction between the silicon and the metal substrate. In conventional annealing steps, the layers react entirely by forming silicides, and so are no longer actively suitable for intercalation of lithium or, generally, of ions.

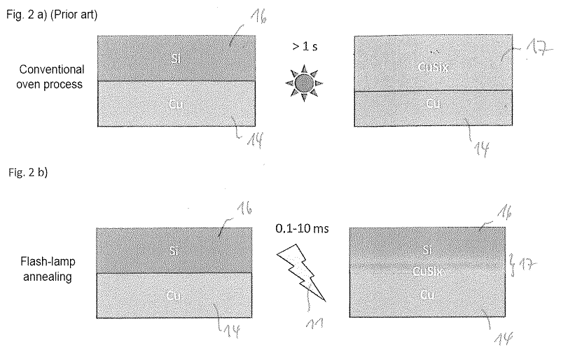

The diffusion of metals into silicon and the reaction of silicon with metals are highly dependent on time and temperature. At temperatures that are already low, starting from 200° C., many metals form a metal silicide whose capacity for reversible lithium intercalation is only very small or does not exist. Diffusion of metals takes place even at room temperature, and very rapidly at elevated temperature, and is difficult to control in conventional oven processes. Taking copper as an example, a complete layer of silicon has undergone reaction right through after no later than 1 s at 600° C. (see FIG. 2a). Diffusion and reaction can be delayed through the installation of diffusion barriers. However, given that typical oven processes are very sluggish relative to the rate of diffusion, the requirements imposed on the diffusion barriers of very exacting. A high layer thickness, nonconductive layers or multiple strata with numerous interfaces are examples for achieving a good barrier effect even at high temperatures. In the semiconductor industry, a special stratum of NiSiₓ is used as a diffusion barrier for metallization with copper, for example, but its production involves multiple process steps and is therefore complicated. Further suitable conductive copper diffusion barriers are, in particular, tungsten (W), tantalum (Ta) and titanium (Ti), and their conductive nitrides and silicides.

WO 2017/140581 A1 describes a method for producing silicon-based anodes for secondary batteries by depositing, on a metal substrate serving as integrated current collector, a silicon (Si) layer and subsequently subjecting it to flash-lamp annealing. A flash-lamp process is usually used so as to melt silicon rapidly and locally and cause it to crystallize, for solar cells, for example. This, however, is not the goal of the method described in WO 2017/140581 A1. Instead, the flash-lamp annealing is employed as follows: generally speaking, crystallization of the silicon can be brought about only at around 700° C. After flash-lamp annealing, these Si atoms are free atoms and are able even at relatively low temperatures, from around 200° C., to diffuse along the grain boundaries in the metal substrate, since the covalent bonding of the Si atoms is weakened at the interface with a metal. This has already been demonstrated for multiple metal/semiconductor systems (e.g., Au/a-Si and Ag/a-Si) and has proven to be energetically favored, as described in the publication by Z. M. Wang, J. Y. Wang, L. P. H. Jeurgens, E. J. Mittemeijer: Thermodynamics and mechanism of metal-induced crystallization in immiscible alloy systems: Experiments and calculations on Al/a-Ge and Al/a-Si bilayers, Physical Review B 77, 045424 (2008). Furthermore, crystallization of the silicon can be achieved through the introduction of metal at comparatively low temperature. This is referred to as metal-induced crystallization. In very simple terms, crystalline growth is able to ensue after the temperature falls below the melting point, and this can be utilized as a criterion for phase transformation. With the method described in WO 2017/140581 A1, multiphase silicon-metal structures can be produced which absorb the change in volume brought about by delithiation and lithiation and which provide for stabilization of the entire material assembly. Lithiation refers to the intercalation of the lithium ions in the host material-for example, the silicon or the graphite.

The Si anodes which can be produced with the method known from WO 2017/140581 A1 are a mix of silicon, pure metals, and silicides, if only a copper (Cu) foil is used as substrate and a silicon layer is deposited thereon-that is, a microstructure is formed which is composed of copper, copper silicide and silicon. The advantages of Si anodes produced in this way relative to Si anodes composed of nanoparticles or nanowires are a high electrical conductivity relative to pure silicon and also conventional graphite, since silicides have an electrical conductivity which is around two orders of magnitude better than that of graphite. Furthermore, the adhesion achieved between the Si layer as active material and the copper substrate is very good, with the copper diffusing from a copper foil into the deposited Si layer as a result of the flash-lamp annealing. The active regions for lithium intercalation, formed by the pure silicon, and the inactive regions, formed by the silicides/metals in the matrix, compensate for the known, deleterious volume expansion during charging. Another advantage is that, because of the stratified construction, only a small area forms a boundary layer with the electrolyte; because of the low surface area, electrolyte decomposition is reduced relative to that with nanostructured active material.

A disadvantage of the method described in WO 2017/140581 A1, however, is that because of the flash-lamp annealing, the Si layer undergoes uncontrolled reaction to form copper silicide, with the conversion reaction always beginning at the Cu-Si layer interface. As a result of the reaction, either there is no silicon left as active material for the intercalation of the lithium, or, if the energy input is so low, sufficient reaction does not take place and, in battery operation, the layer lacks adequate stability and so leads to a loss of capacity on the part of the battery. For a sufficient target capacity in the production of the lithium battery, sufficiently thick Si layers (up to 10 μm) are necessary. If the conversion reaction of Cu+Si to form copper silicide is triggered in an uncontrolled way by an annealing method, including by flash-lamp annealing, the entire copper substrate, a copper foil for example, would react completely with the silicon to form copper silicide and would be accompanied by the loss of the current collector of the lithium battery. It is therefore not possible with the method described in WO 2017/140581 A1 to produce stable structures and anodes with high areal storage density.

The object of the present invention is therefore to specify a method which allows control of the capacity for ion intercalation into functional layers for battery production. For lithium-ion batteries in particular, the proportions of silicon to silicide and metal ought to be able to be established in a controlled manner-that is, a method for producing partially reacted silicon would be advantageous. The intention was to find a trade-off between the maximum proportion of pure silicon, ideally amorphous or nanocrystalline, which must be available as active material for lithium intercalation, with at the same time a sufficient quantity of inactive regions in order to achieve stability and good electrical conductivity, and to provide for high capacity with a sufficient anode layer thickness with a high proportion of silicon.

The object is achieved by a method in accordance with independent claim 1.

In the method for producing partially reacted silicon for controlling the lithium intercalation capacity, for use in lithium batteries, wherein a first silicon layer is deposited on a substrate and is subsequently subjected to accelerated annealing, a stratum of silicon, metal and/or a further material is applied in accordance with the invention as a diffusion barrier, which is subjected to subsequent accelerated annealing and, consequently, a stratum of partially reacted silicon is formed. The deposition and the accelerated annealing are repeated a further time, to form a multi-stratum construction composed of partially reacted silicon.

Accelerated annealing refers in particular to flash-lamp annealing and/or laser annealing. Flash-lamp annealing takes place with a pulse duration or annealing time in the range from 0.3 to 20 ms and a pulse energy in the range from 0.3 to 100 J/cm². In the case of laser annealing, the annealing time of 0.01 to 100 ms is established through the rate of scanning of the local heating site, to generate an energy density of 0.1 to 100 J/cm². The heating ramps achieved in the accelerated annealing are situated in the range, necessary for the method, of 10\hat{ }4-10\hat{ }7 K/s. Flash-lamp annealing for this purpose utilizes a spectrum in the visible wavelength range, whereas for laser annealing, discrete wavelengths in the range of the infrared (IR) to ultraviolet (UV) spectrum are used.

The sequence of the strata produces an overall layer thickness in the multi-stratum construction of typically 4-15 μm of partially reacted silicon, which is sufficient for battery operation. Partially reacted silicon in the sense of the invention refers to a layer which comprises regions of pure silica, ideally amorphous or nanocrystalline, and regions of corresponding silicides, which have been formed by partial to complete reaction with the metal.

A stratum in the sense of this invention refers to a layer sequence of silicon, a metal and/or a further material, serving as a diffusion barrier, which together result in a defined, partially reacted silicon layer which is formed by accelerated annealing. A stratum is therefore a layer sequence which produces a defined, partially reacted silicon/silicide layer. The diffusion barrier limits the externally supplied quantity of metal; the quantity of metal supplied in the stratum is available for defined reaction with silicon supplied in this stratum. A silicide layer formed may already serve as a sufficient diffusion barrier to prevent further reaction with silicon, removing the absolute need for an additional diffusion barrier composed of a further material other than the metal. In that case, the rate of diffusion of metals into silicides is lower than into silicon.

Accelerated annealing allows control over the diffusion and the formation of silicide in a layer, and so there is a gradual course in the formation of silicide perpendicularly to the surface. This is advantageous for the adhesion of the Si layer to copper foil, as silicide is formed partially and yet active silicon is available. Process control in the accelerated annealing can be improved by using suitable diffusion barriers. Retarding diffusion on passage through a barrier permits greater process control in the time interval in which energy is introduced during the accelerated annealing. Unlike conventional diffusion barriers, the aim is to attenuate the diffusion of metal atoms only to such an extent that, in the time window in which energy is introduced during the accelerated annealing, there is markedly reduced diffusion in contrast to the diffusion of the metal atoms into silicon. Correspondingly, the architecture and thickness of the diffusion barrier in the method of the invention is greatly simplified, allowing savings to be made in terms of material and process time. At the same time, the diffusion of lithium is not reduced, or is reduced only to a small extent, and is therefore suitable for application in a lithium-ion battery. A suitable diffusion barrier is therefore understood as a barrier which locally attenuates the diffusion particularly of copper during accelerated annealing, and inhibits the formation of silicide, but at the same time permits diffusion of lithium.

In one embodiment of the method of the invention, diffusion and reaction of metal with the silicon in the case of flash-lamp annealing is controlled by a pulse duration in the range from 0.3 to 20 ms, a pulse energy in the range from 0.3 to 100 J/cm² and preheating or cooling in the range from 4° C. to 200° C. in the flash-lamp annealing, and therefore partially reacted silicon is generated in each stratum.

Where laser annealing is used as the accelerated annealing, diffusion and reaction of metal with the silicon is controlled by an annealing time in the range from 0.01 to 100 ms through the establishment of a rate of scanning of a local heating site and an energy density in the range from 0.1 to 100 J/cm² and by preheating or cooling in the range from 4° C. to 200° C. in the laser annealing, and therefore partially reacted silicon is generated in each stratum. An effect of external cooling is that the cooling-down of the substrate is controlled more effectively. Otherwise, there may be unwanted reactions outside the annealing region.

The metal may be the copper from a copper substrate on which the multi-stratum construction is deposited for producing the active layer of an anode for lithium batteries. The diffusion of copper into a silicon layer may be controlled by the adjustable pulse duration and pulse energy and the preheating or the cooling in the flash-lamp annealing. A gradual course without entire reaction of the layer is possible. In the region of the Cu foil, a high concentration of copper can be measured, which gradually disappears until the surface of the deposited layer is reached. Accordingly, in the region of the Cu foil, a large proportion is reacted to form copper silicide. A chemical reaction of the boundary region occurs, and greatly improves the adhesion of the layer. Because of the high proportion of silicide, less/no lithium is intercalated, and so the volume expansion is lower and the stress at the interface is significantly reduced. With the gradual construction of the layer, the stress of the volume expansion on lithium intercalation is distributed uniformly in the layer. A single-stratum Si layer treated with the accelerated annealing exhibits a greatly improved cycling stability with virtually no change in the utilization of the Li storage capacity relative to untreated layers. A cycle refers to the complete charging and discharging of a battery. The number of cycles is linked to the lifetime of a battery. It is disadvantageous, however, that downstream annealing steps cause further reaction of the layer and hence limit the construction to one annealing step or just a few strata. Through the use of suitable diffusion barriers as intermediate strata, this disadvantage can be circumvented or adapted to the target thickness of the overall layer. Suitable copper diffusion barriers are recited later on below.

In another embodiment of the method of the invention, diffusion and reaction of metal from the substrate with the silicon is controlled by a diffusion barrier applied beforehand.

So that the multi-stratum structure applied to the substrate does not undergo uncontrolled reaction with the metal, copper for example, to form silicide, a diffusion barrier may be applied as first layer to the substrate. This layer has a sufficient barrier effect, so making it possible for example, on flash-lamp annealing, to control the diffusion and reaction of the metal atoms from the substrate with the silicon by means of the flash energy, the flash duration, or else minimal adaptations to the thickness of the diffusion barrier layer.

In another embodiment of the method of the invention, the strata are deposited via physical vapor deposition, such as sputtering or vaporization, for example, or via chemical vapor deposition.

Planar deposition by sputtering or vaporization, for example, or via chemical vapor deposition allows the introduction of diffusion barriers stratum by stratum without increased complexity and expense. In contrast to diffusion barriers for conventional annealing processes, the requirements imposed on the diffusion barriers in the context of accelerated annealing are relatively minor-diffusion need only be sufficiently hindered rather than prevented entirely, as described above. Accordingly, extremely thin barriers of suitable elements and compounds, such as carbon, nitrides, oxides, metals, are sufficient to allow stable process control in the method of the invention (stable process window). As a result, multiple annealing steps are possible with only small change in the layer construction. A stratum in the method of the invention is understood synonymously with a layer stack of Si, metal and/or a diffusion barrier composed of a further material; a stratum in the sense of the invention therefore consists of component layers of a layer stack. Multiple strata form a multi-stratum structure.

In a further embodiment of the method of the invention, the diffusion barriers are applied from one of the materials titanium (Ti), nickel (Ni), aluminum (Al), tin (Sn), gold (Au), silver (Ag), molybdenum (Mo), tungsten (W), carbon (C) and/or mixtures of these materials.

In a different further embodiment of the method of the invention, volume expansion of the silicon in each stratum of the multi-stratum construction is controlled by the partially reacted silicon, with a gradual course from a high silicide concentration on the side of the multi-stratum construction facing the substrate to a low silicide concentration on the side of the multi-stratum construction facing away from the substrate being established.

The gradual course is approximated step by step by means of the multi-stratum construction. For the silicon in each stratum of the multi-stratum structure or multi-stratum construction and in the subsequent accelerated annealing, the aim is to maximize the reaction of Si with the metal/copper present. As a result, the concentration of metal/copper is reduced with each stratum, and the last stratum of the multi-stratum structure that is constructed is virtually (<5%) metal-free/copper-free silicon.

In one embodiment of the method of the invention, reaction of metal and silicon to form silicide is controlled across strata by introduction of diffusion barriers into a stratum to be deposited and the frequency of the accelerated annealing can be reduced as the number of strata increases.

After each stratum of silicon, a diffusion barrier is inserted. This corresponds to the and conjunction in independent claim 1. It is therefore possible to reduce the energy input by reducing the number of accelerated annealing operations. In this way, a gradual construction may likewise be generated and produced by the maximum possible sequence of strata with only one accelerated annealing operation at the end of the multi-stratum construction.

In one embodiment of the method of the invention, for each stratum of silicon, metal and diffusion barrier to be deposited, an adjustable amount of metal, more particularly copper, nickel, aluminum, titanium, magnesium and/or tin, is inserted, so as to generate partially reacted silicon in the entire multi-stratum structure. The aim and the advantage of adding an adjustable amount of metal into each stratum of the multi-stratum construction is the generation of a conductive matrix into which silicon is embedded. Furthermore, it serves to increase the conductivity of silicon as dopant. A reduction in lithium storage capacity is admittedly a side-effect of the partial reaction with silicon to form a non-lithium-reactive silicide/composite; however, this reduces the critical volume expansion of silicon on lithium intercalation. Where the first deposited stratum of silicon, metal and/or diffusion barrier on the substrate is treated by accelerated annealing, there may be no copper available from the substrate for a subsequently deposited stratum to form silicide. The adjustable amount of a metal, more particularly Cu, Ni, Al, Ti, Mg and/or Sn, is added to ensure partially reacted silicon in each stratum in the case of a multiplicity of strata. The amount of metal can be varied via the amount of Si in order likewise to produce a gradual construction. Accelerated annealing takes place after one or more deposited strata, in order to ensure reaction in these strata.

The metal deposited may comprise nickel, for example. Nickel reacts with silicon to form nickel silicide and at the same time constitutes a diffusion barrier for copper. As a result, the production process can be simplified by means of fewer individual steps. With nickel it is likewise possible to realize a gradual construction of a partially reacted silicon layer.

The multiple accelerated annealing allows thick layers of an active layer with silicon to be constructed for a high lithium intercalation capacity. Controlling the diffusion with the aid of the stratified construction allows entirely new variants of stratified constructions. Any desired functional layers can be constructed and adjusted in a targeted way, by the accelerated annealing, to their properties as necessary for stable battery operation. For example, using sputtered carbon, it is possible to inhibit the diffusion of Cu into silicon, whereas deposited Cu₃Si may also boost the diffusion of Cu into silicon. Optimization for other purposes of use, such as other kinds of batteries (aluminum-ion (Al), sodium (Na) or magnesium (Mg) batteries, etc.) and also thermoelectric systems, are likewise possible as a result of the high flexibility.

The method of the invention may therefore be used advantageously for producing functional layers in an aluminum-ion battery, for thermoelectric systems and/or for sodium batteries or magnesium batteries.

The multiple accelerated annealing allows targeted admixing of metal, copper for example, into the silicon, so that strata with defined concentrations may be produced by targeted formation of silicide, and the capacity for incorporation of lithium into silicon may be adjusted. Other metals, such as Ti, Ni, Sn, Al, W, Mo, C and/or mixtures of these, are possible according to requirements. A gradual construction, stratum by stratum, is consequently possible.

The object of the invention is likewise achieved by an anode in accordance with independent claim 12.

The anode is suitable for use in a lithium battery and is produced with the method according to the method claims. The anode of the invention comprises a current collector, preferably of copper, and a multi-stratum structure which is deposited on the current collector and forms an active layer of the anode, with the multi-stratum structure being formed of at least one first partially reacted silicon layer, which consists of silicon, metal and/or a further material and is subjected to accelerated annealing, and of a second partially reacted silicon layer which consists of silicon, metal and/or a further material and which is likewise subjected to accelerated annealing.

The first applied silicon layer with subsequent accelerated annealing may function advantageously as an adhesive layer, with the first silicon layer reacting fully with the copper of the current collector to form copper silicide; as a result, the roughness of the current collector, a Cu foil for example, is increased, high adhesion is produced, and the silicon layer reacted with the copper serves as an adhesive layer for further stratum construction. Since the copper silicide layer is fully reacted, the applied diffusion barrier composed of a further material, such as of carbon, for example, guarantees a sufficiently stable diffusion barrier during the subsequent processing steps as well. This diffusion barrier is needed to prohibit reaction of silicon in copper, to form copper silicide, on further accelerated annealing, especially flash-lamp annealing and/or laser annealing. The further Si, metal and/or diffusion barrier layers of a further material sequentially applied thereafter are stabilized by further accelerated annealing. The anode of the invention for a lithium battery has a high storage capacity of up to 4 mAh/cm², or even up to 6 mAh/cm².

In one embodiment of the anode of the invention, volume expansion of the silicon of the multi-stratum structure on lithium intercalation is controllable by the partially reacted silicon layer, with a gradual course from a high silicide concentration on the side of the active layer facing the current collector to a low silicide concentration on the side of the anode active layer facing away from the current collector being developed and with high electrical conductivity in the anode active layer being developed by the proportion of the metal in the multi-stratum structure. Good electrical conductivity refers to a resistivity in the graphite range of 3*10⁻³ ohm cm; high conductivity refers to a resistivity less than that of graphite through to pure copper silicides, of (10 to 50)*10⁻⁶ ohm cm.

The gradual course of a layer is approximated step by step by means of the multi-stratum construction. For each stratum of Si and subsequent accelerated annealing, the aim is to maximize the reaction of Si with the metal present, copper for example. As a result, the concentration of copper is reduced with each stratum, and the last stratum that is constructed is virtually (<5%) copper-free silicon.

In each deposited stratum of silicon, metal and diffusion barrier, the amount of metal, which more particularly may be copper, nickel, aluminum, titanium, magnesium and/or tin, is adjustable, so as to generate partially reacted silicon in the entire multi-stratum structure. The aim and the advantage of the added amount of metal into each stratum of the multi-stratum construction being adjustable is the generation of a conductive matrix into which silicon is embedded. The adjusted amount of metal serves to increase the conductivity of silicon as dopant. A reduction in lithium storage capacity is admittedly a result of the partial reaction with silicon to form a non-lithium-reactive silicide/composite; however, this reduces the critical volume expansion of silicon on lithium intercalation.

In a further embodiment of the anode of the invention, the further material forms a diffusion barrier, the diffusion barrier being formed of one of the materials titanium (Ti), nickel (Ni), aluminum (Al), tin (Sn), gold (Au), silver (Ag), molybdenum (Mo), tungsten (W), carbon (C) and nitrides and silicides thereof and/or mixtures of these materials.

The anode of the invention may have a diffusion barrier after each stratum of silicon. It is possible accordingly to reduce the energy input by reducing the number of accelerated annealing operations in the production of the anode. In this way, it is likewise possible to produce a gradual construction of the active layer of the anode through a maximum possible stratum sequence with only one accelerated annealing operation. Nickel, for example, may be used as a diffusion barrier. Nickel reacts with silicon to form nickel silicide and at the same time constitutes a diffusion barrier for copper. An anode constructed in this way can be fabricated from fewer individual steps.

In a different embodiment of the anode of the invention, the anode exhibits a gradual course of a metal concentration from a high concentration on the side of the active layer facing the current collector to a low concentration on the side of the anode active layer facing away from the current collector. The non-active region in the heterogeneous construction of the overall layer comprises at least the concentration of a copper-3 silicide (Cu₃Si) through Cu₇Si and on to pure copper. Below the concentration of Cu₃Si, the silicon is said to have high to very high copper concentration. Taken as a lower limit for silicon of high metal concentration is the typical value of metallurgical silicon, at ˜3% metal. From a value of less than 0.1% metal in silicon, the silicon is said to have a low metal concentration.

In a different further embodiment of the anode of the invention, the anode comprises a gradual course of a metal concentration in a stratum of the multi-stratum structure, with regions having a high silicide concentration developing adhesion and stability of the active layer, and regions having a low silicide concentration and high proportion of silicon exhibiting high lithium intercalation capacity. A high silicide concentration refers to a proportion of more than 50% of silicide in the stratum, whereas a low silicide concentration refers to a proportion of less than 10% of silicide in the stratum.

The invention will be elucidated in more detail below, using exemplary embodiments.

In the drawings

FIG. 1 shows an illustrative construction and function of a lithium-ion cell during discharging;

FIG. 2 shows the influence of temperature input on formation of silicide in a silicon anode a) in a conventional oven process (prior art), and b) with accelerated annealing, more particularly flash-lamp annealing;

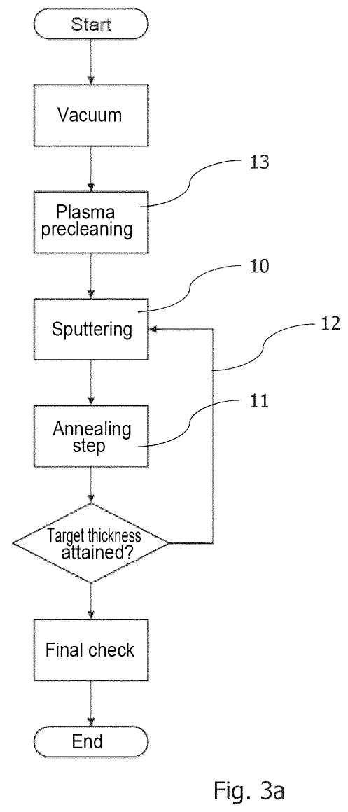

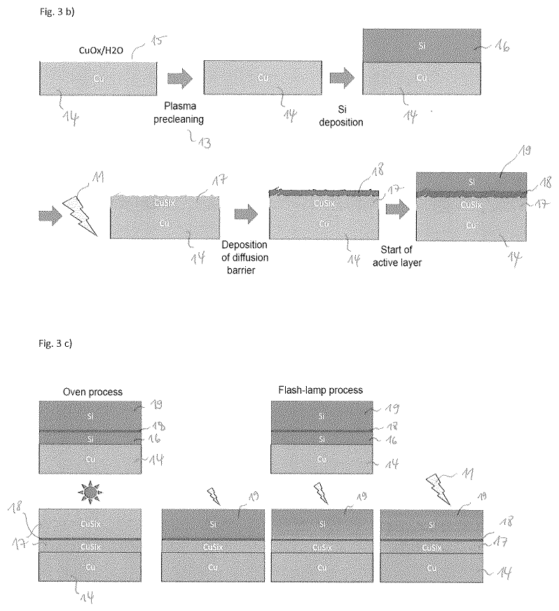

FIG. 3 shows a) a process flow diagram of the method of the invention; b) a schematic representation of the method of the invention for controlling the lithium intercalation capacity through targeted accelerated annealing, more particularly flash-lamp annealing, of functional layers for battery production; c) the development of a gradual course of the formation of silicide in accordance with the method of the invention;

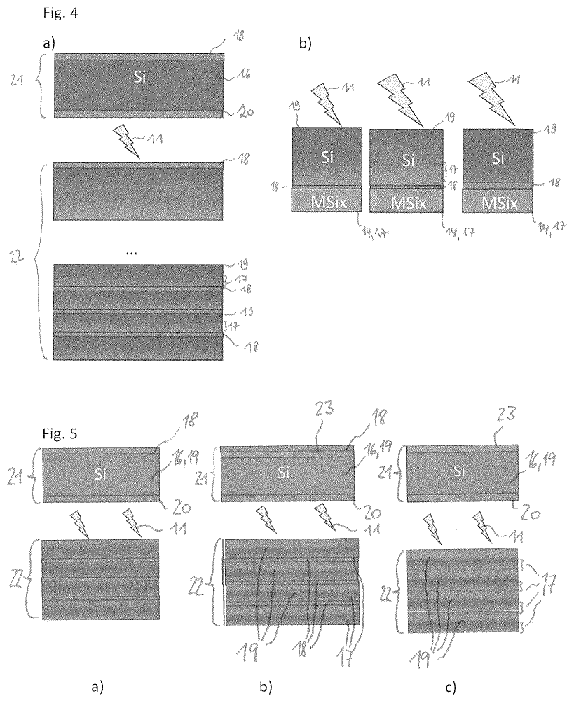

FIG. 4 a schematic representation of a multi-stratum construction according to the method of the invention for producing partially reacted silicon for controlling the lithium intercalation capacity: a) single stratum and multi-stratum structure composed of multiple strata of silicon, metal and diffusion barriers; b) the influence of the accelerated annealing process parameters and thickness of the diffusion barrier on the gradual course of the silicon/silicide concentration in a stratum;

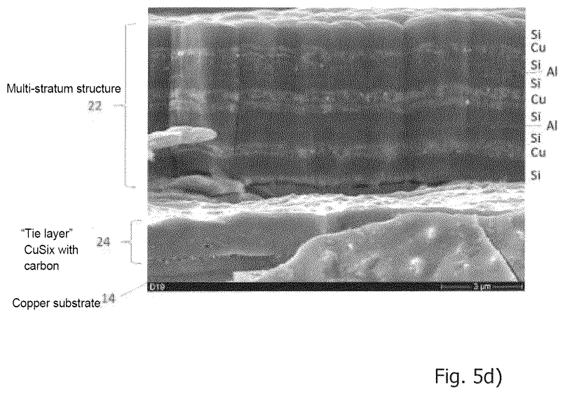

FIG. 5 a) a schematic representation of the multi-stratum structure as active layer of the anode of the invention; b) gradual course of the silicide concentration established by controlled addition of metal, copper for example, into each stratum of the multi-stratum structure separated by diffusion barriers; c) gradual course of the metal concentration in each stratum of the multi-stratum structure without diffusion barriers;

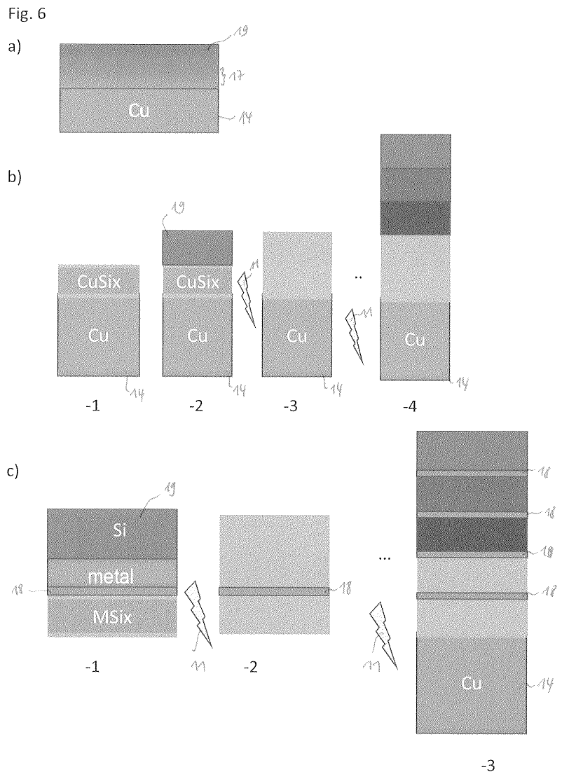

FIG. 6 schematic representation of the gradual course of the silicon concentration/metal concentration/silicide concentration on a copper substrate: a) within an individual stratum; b) without and c) with diffusion barriers between the individual strata;

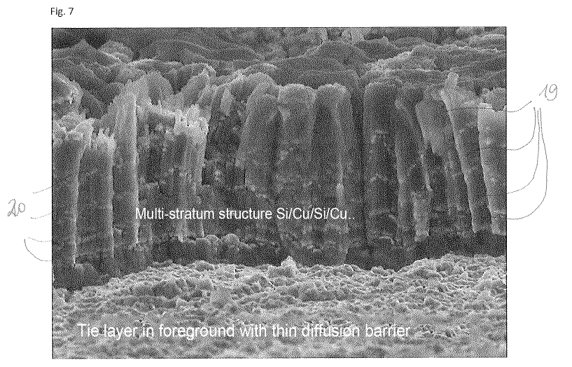

FIG. 7 SEM micrograph of a multi-stratum structure without diffusion barriers.

FIG. 2b) shows the influence of the accelerated annealing, more particularly flash-lamp annealing, on the formation of silicide in a layer system of copper and silicon. Because of the very short flash pulse in the range from 0.1 to 10 ms, the reaction of the silicon with the copper to form copper silicide is incomplete. The flash-lamp annealing leaves pure amorphous or nanocrystalline silicon, which is available as active material for lithium intercalation, with a sufficient number of inactive regions at the same time, which ensure stability and good electrical conductivity.

FIG. 3a) shows the method steps of the invention in a flow diagram, and FIG. 3b) shows the flow of the method steps with reference to the generated anode construction, in comparison to a conventional oven process in the left-hand part of FIG. 3c). A substrate 14, which serves simultaneously as current collector in an LIB (lithium-ion battery), undergoes precleaning 13 under vacuum conditions in a plasma atmosphere. This cleaning is necessary because, in air, an oxidation layer 15 is formed on the substrate 14, which would prevent reaction between a subsequently applied silicon layer 16 and the copper substrate 14 in a flash-lamp annealing operation (FLA-flash-lamp annealing) and would therefore mean that the silicon layer 16 did not adhere to the Cu substrate. This is followed by the deposition of a first silicon layer 16, via sputtering, for example. This first silicon layer 16 reacts with the Cu substrate 14 in a transition region to form copper silicide 17, thereby increasing the roughness of the substrate 14, a Cu foil for example, with the silicon layer with the copper serving as a kind of adhesive layer for further stratum construction. The copper silicide layer 17 is completely inactive in a battery, and so first a diffusion barrier 18, composed of carbon, for example, is applied in a subsequent step. This diffusion barrier 18 is necessary to prevent reaction of silicon in copper to form copper silicide on further flash-lamp annealing. Subsequently, further Si layers 19 may be sequentially applied; the strata, each formed from silicon and a diffusion barrier layer, are stabilized by flash-lamp annealing 11. The advantage of the repeated Si deposition and subsequent flash-lamp annealing 11 is that, with each sequence, a stable (“reaction-neutralized”) layer with a closed-off interface is formed which acts as an intermediate layer for the subsequent strata. This is advantageous for the adhesion of the Si layer to copper foil, since there is partial formation of copper silicide and yet active silicon is available. The method of the invention described therefore additionally brings about roughening of the surface, forming a good adhesion for further layers. The growth of column structures is likewise promoted, and so the ionic conductivity is better and the copper fraction can be readily controlled for downstream processes.

After repeated deposition of silicon, metal and/or diffusion barriers composed of a different material, and subsequent accelerated annealing, more particularly flash-lamp annealing, therefore, the diffusion and formation of silicide in a layer may be controlled, so making it possible to establish a gradual course of the formation of silicide perpendicularly to the surface. This is shown in FIG. 3c) in comparison to a conventional oven process. In an oven process, the Cu substrate 14 is heated with the deposited Si layers 16, 19 and the diffusion barrier 18. The diffusion barrier 18, composed of carbon or nickel, for example, does not have sufficient barrier effect, and so the entire silicon reacts with the copper to form copper silicide 17.

The situation is different when the layer undergoes accelerated annealing via flash lamp or laser. Process control during flash-lamp or laser annealing may be sharply improved by the introduction of suitable diffusion barriers 18. Copper silicide formation, by the adjustment to the flash lamp energy, the flash lamp duration and/or the annealing time, by means of adjusting a rate of scanning of the local heating point and an energy density via laser and/or by minimal adaptation of the thickness of the deposited silicon layer or diffusion barrier, may be gradually adjusted; this is represented in FIG. 3c) on the right-hand side. The use of diffusion barriers 18 in conjunction with the accelerated annealing, more particularly flash-lamp annealing and/or laser annealing 11, is suitable for controlling the intercalation of ions in the production of batteries.

A further exemplary embodiment is shown by FIG. 4. FIG. 4a) shows, at the top, an individual stratum 21 composed of a copper layer or, generally, metal layer 20, a silicon layer 16 and a diffusion barrier 18. Each stratum 21 may be treated by accelerated annealing 11, causing the silicon 16 and the metal 20 to be transformed into a silicide 17; by adjusting the parameters of the accelerated annealing process 11, a gradual profile of the silicide/silicon concentration in a stratum is developed. Multiple strata 21 form a multi-stratum structure 22.

The gradual course of the silicide/silicon concentration in a stratum 21 may be adjusted both through the chosen process parameters in the accelerated annealing process 11 and through the thickness of the deposited diffusion barrier 18. This is represented schematically in FIG. 4b). The higher the chosen energy input by the flash lamp or the laser 11, for example, the greater the number of metal atoms that can diffuse into the silicon layer 19 during the accelerated annealing process, and hence the smaller the gradient of the silicide/silicon concentration in the stratum (compare FIG. 4b), left-hand and middle diagrams). A small gradient is synonymous with a gradual decrease in the concentration of silicide in a stratum or in the anode active layer, from the side of the stratum/active layer facing the current collector to the side of the stratum/active layer facing away from the current collector. A high gradient means that the silicide concentration decreases rapidly. If the thickness of the diffusion barrier 18 is increased, with accelerated annealing process parameters unchanged, there is an increase in the gradient within the deposited stratum, since fewer metal atoms are able to diffuse through the diffusion barrier 18 into the deposited stratum within the accelerated annealing operation, and hence the concentration is reduced over a shorter distance perpendicular to the surface of the stratum/active layer. A high silicide concentration is formed on the bottom side of the stratum, which decreases rapidly; on the top side, i.e., the side of the stratum/active layer facing away from the current collector, there is now only silicon present. The pure silicon is available for the intercalation of lithium, whereas the formation of silicide increases the electrical conductivity.

The gradual course of, for example, the copper concentration in a silicon layer with a copper layer is established through adaptation of the pulse duration, the preheating or cooling of the stratified construction, and a layer thickness of the strata deposited, in other words by adaptation of the energy input (over time and temperature) and the thickness ratio of the silicon layer to the copper layer; the mean reaction depth (diffusion length) is to be less than the layer thickness of the silicon layer, in order to provide sufficient unreacted silicon for lithium intercalation.

FIG. 5 shows the schematic representation of the multi-stratum structure as an active layer of the anode of the invention in different exemplary embodiments. In FIG. 5a) there is a stratum 21 composed of silicon 16, 19, metal 20, 23 and a diffusion barrier 18. This stratum is subjected to accelerated annealing 11. Multiple strata 21 and multiple accelerated annealing operations 11 form a multi-stratum construction 22, with the strata being separated by a diffusion barrier 18, composed of carbon, for example, and with additional metal 20 being introduced into the further strata. Each stratum is subsequently subjected to accelerated annealing 11. The gradual course of the silicide concentration within each stratum is clearly apparent, starting from the metal stratum 20.

FIG. 5b) additionally to FIG. 5a) shows the gradual course of the silicide concentration in each stratum of the multi-stratum structure 22 separated by diffusion barriers 18 composed of carbon, for example. Additionally, in each stratum, a further stratum of metal 23, aluminum for example, is introduced. This allows further refinement of the gradual course and the reaction of metal with silicon in each stratum.

FIG. 5c) shows the same construction of a multi-stratum structure 22 as in FIG. 5b), with the difference that there are no diffusion barriers 18 separating the individual strata 21 from one another in the multi-stratum construction 22. The gradual course is controlled by the thickness of the inserted metal stratum 20 and 23. An SEM micrograph showing an illustrative Si/Cu/Si/Al/Si/Cu/Si/Al/Si construction is depicted in FIG. 5d). The intermediate strata are no longer clearly apparent; after flash-lamp annealing, the copper reacts with the silicon to form CuSiₓ, which is recognizable as wide light-colored regions. The aluminum “dissolves” in silicon. The result is a readily conductive, multi-membered, stable, multi-stratum structure with a high silicon fraction, i.e., high battery capacity. On the copper substrate 14 a CuSiₓ tie layer 24 has developed with carbon, and ensures continuous current contact.

FIG. 6 shows the schematic representation of the generation of a gradual course of the silicon concentration or metal concentration or silicide concentration on a copper substrate: FIG. 6a) shows a single stratum of silicon with an Si thickness at which the reaction of silicon and metal to form a silicide is still controllable through the choice of the flash-lamp process parameters. The layer thickness here is limited to the maximum thickness of silicon, which in process terms is stable before the flash-lamp annealing, typically 1 μm. FIG. 6b) shows the generation of the gradual course starting from a copper substrate with a single stratum of silicon, which after flash-lamp annealing 11 is fully reacted to form a copper silicide (FIG. 6b-1); subsequently, an additional silicon layer 19 is deposited (FIG. 6a-2), and subsequently reacts, after flash-lamp annealing 11, to form a less pronounced silicide layer (FIG. 6a-3); a concentration gradient is already apparent here. After further depositions of silicon layers and flash-lamp annealing operations 11, a virtually gradual course is produced in the multi-stratum layer construction (FIG. 6a-4).

FIG. 6c) shows the generation of a gradual course of the silicon concentration or metal concentration or silicide concentration on a copper substrate with diffusion barriers 18, multiple silicon strata 19, and flash-lamp annealing 11 between each of the individual strata. Here, the reaction and both the degree and the amount of the silicidation can be controlled in a significantly more targeted manner in each stratum, relative to FIG. 6b), in order to generate a gradual construction. With increasing distance within the active layer perpendicular to the surface of the copper substrate 14, the concentration of silicon goes up/the concentration of silicide goes down. The establishment and adaptation of the flash-lamp annealing process parameters allow the gradients to be established in a targeted manner starting from one or more strata of silicon. In contrast to FIG. 6a), the multi-stratum construction from FIG. 6b)-4 and also FIG. 6c)-3 has the advantage of better control over the transition from silicide 17 to silicon 19 and permits the construction of greater layer thicknesses.

FIG. 7 shows an SEM micrograph of a multi-stratum structure 22 composed of Si/Cu/Si/Cu etc. without diffusion barriers 18 between the individual strata. Only a thin diffusion barrier has been applied to the substrate, as a tie layer.

### LIST OF REFERENCE SIGNS

1 lithium-ion battery
2 collector on anode side
3 SEI—solid-electrolyte interphase
4 electrolyte
5 separator
6 contacting interphase
7 cathode, positive electrode
8 collector on cathode side
9 anode, negative electrode
10 sputtering of Si layer
11 flash-lamp annealing
12 repetition of process steps
13 plasma precleaning
14 substrate
15 oxidation layer
16 first silicon layer
17 copper silicide; metal silicide
18 diffusion barrier
19 further silicon layer
20 metal layer
21 single stratum
22 multi-stratum structure, construction
23 further metal layer
24 tie layer

1. A method for producing partially reacted silicon for controlling the lithium intercalation capacity, for use in lithium batteries, wherein a first silicon layer is deposited on a substrate and is subsequently subjected to accelerated annealing, characterized in that a stratum of silicon, metal and/or a further material is applied as a diffusion barrier which is subjected to subsequent accelerated annealing and partially reacted silicon is formed.

2. The method for producing partially reacted silicon for controlling the lithium intercalation capacity as claimed in claim 1, characterized in that the deposition and the accelerated annealing is subsequently repeated a further time, to form a multi-stratum construction composed of partially reacted silicon.

3. The method for producing partially reacted silicon for controlling the lithium intercalation capacity as claimed in claim 1, characterized in that diffusion and reaction of metal in flash-lamp annealing with the silicon is controlled by a pulse duration in the range from 0.3 to 20 ms, a pulse energy in the range from 0.3 to 100 J/cm², and preheating or cooling in the range from 4° C. to 200° C. in the flash-lamp annealing so as to generate partially reacted silicon in each stratum.

4. The method for producing partially reacted silicon for controlling the lithium intercalation capacity as claimed in claim 1, characterized in that diffusion and reaction of metal in laser annealing with the silicon is controlled by an annealing time in the range from 0.01 to 100 ms through the establishment of a rate of scanning of a local heating site and an energy density in the range from 0.1 to 100 J/cm² and also preheating or cooling in the range from 4° C. to 200° C. in the laser annealing so as to generate partially reacted silicon in each stratum.

5. The method for producing partially reacted silicon for controlling the lithium intercalation capacity as claimed in claim 1, characterized in that diffusion and reaction of metal from the substrate with the silicon is controlled by a diffusion barrier applied beforehand.

6. The method for producing partially reacted silicon for controlling the lithium intercalation capacity as claimed in claim 1, characterized in that the strata are deposited via physical and/or via chemical vapor deposition.

7. The method for producing partially reacted silicon for controlling the lithium intercalation capacity as claimed in claim 1, characterized in that the diffusion barriers are formed from one of the materials titanium (Ti), nickel (Ni), aluminum (Al), tin (Sn), gold (Au), silver (Ag), molybdenum (Mo), tungsten (W), carbon (C) and nitrides and silicides thereof and/or mixtures of these materials.

8. The method for producing partially reacted silicon for controlling the lithium intercalation capacity as claimed in claim 1, characterized in that the diffusion barriers permit lithium diffusion.

9. The method for producing partially reacted silicon for controlling the lithium intercalation capacity as claimed in claim 1, characterized in that volume expansion of the silicon in a stratum of the multi-stratum construction is controlled by the partially reacted silicon to silicide, with a gradual course from a high silicide concentration on the side of the multi-stratum construction facing the substrate to a low silicide concentration on the side of the multi-stratum construction facing away from the substrate being established.

10. The method for producing partially reacted silicon for controlling the lithium intercalation capacity as claimed in claim 1, characterized in that reaction of metal and silicon to form silicide is controlled across strata by introduction of diffusion barriers and the frequency of the accelerated annealing is reduced as the number of strata increases.

11. The method for producing partially reacted silicon for controlling the lithium intercalation capacity as claimed in claim 1, characterized in that for each stratum of silicon (16, 19), metal (20, 23) and diffusion barrier to be deposited, an adjustable amount of metal (23), more particularly copper (Cu), nickel (Ni), aluminum (Al), titanium (Ti), magnesium (Mg) and/or tin (Sn), is inserted in order to generate partially reacted silicon in the entire multi-stratum structure.

12. An anode suitable for use in a lithium battery and produced by the method as claimed in claim 1, characterized in that the anode (9) comprises a current collector, preferably composed of copper, and a multi-stratum structure which is deposited on the current collector and forms an active layer of the anode, with the multi-stratum structure being formed of at least one first partially reacted silicon layer, which consists of silicon, a metal and/or a further material and is subjected to accelerated annealing, and of a second partially reacted silicon layer, which consists of silicon, a metal and/or a further material and is likewise subjected to accelerated annealing.

13. The anode as claimed in claim 12, produced by the method as claimed in claim 1, characterized in that volume expansion of the silicon of the multi-stratum structure on lithium intercalation can be controlled by the partially reacted silicon layer, with a gradual course from a high silicide concentration on the side of the active layer facing the current collector to a low silicide concentration on the side of the anode active layer facing away from the current collector being developed and with high electrical conductivity in the anode active layer being developed by the proportion of the metal in the multi-stratum structure.

14. The anode as claimed in claim 12, characterized in that the further material forms a diffusion barrier, the diffusion barrier being formed of one of the materials titanium (Ti), nickel (Ni), aluminum (Al), tin (Sn), gold (Au), silver (Ag), molybdenum (Mo), tungsten (W), carbon (C) and nitrides and silicides thereof and/or mixtures of these materials.

15. The anode as claimed in claim 12, characterized in that the anode active layer has a layer thickness of 4 to 15 μm.

16. The anode as claimed in claim 12, characterized in that the anode comprises a gradual course of a metal concentration in the active layer from a high metal concentration on the side of the active layer facing the current collector to a low metal concentration on the side of the anode active layer facing away from the current collector.

17. The anode as claimed in claim 16, characterized in that the anode comprises a gradual course of a metal concentration in a stratum of the multi-stratum structure, with regions having a high silicide concentration developing adhesion and stability of the active layer, and regions having a low silicide concentration and high proportion of silicon exhibiting high lithium intercalation capacity.

18. The use of the method for producing partially reacted silicon for controlling the lithium intercalation capacity as claimed in claim 1 for functional layers in an aluminum-ion battery.

19. The use of the method for producing partially reacted silicon for controlling the lithium intercalation capacity as claimed in claim 1 for thermoelectric systems.

20. The use of the method for producing partially reacted silicon for controlling the lithium intercalation capacity as claimed in claim 1 for sodium batteries or magnesium batteries.
